(19) United States
(12) Patent Application Publication
(10) Pub. No.: US 2011/0221601 A1
(43) Pub. Date: Sep. 15, 2011

(54) Detecting Engagement Conditions Of A Fiber Optic Connector

(76) Inventor: Jerry Aguren, Tomball, TX (US)

(21) Appl. No.: 12/722,708

(22) Filed: Mar. 12, 2010

(51) Int. Cl. G08B 21/00; H04B 10/08

(52) U.S. Cl. 340/653; 398/9

(57) ABSTRACT

A fiber optic device is connectable to a fiber optic cable connector to provide an optical communication channel. The fiber optic device is operable to detect a plurality of engagement conditions of the fiber optic device relative to the connector and to provide output signals indicative of a present engagement condition. Some embodiments provide a transceiver, and during insertion of a cable connector into the transceiver different electrical signals are provided to engagement status logic, corresponding to different levels of insertion of the connector into the transceiver

### BACKGROUND

Communications and information technology (IT) systems are known to employ fiber optic cables respectively connected by cable end connectors to fiber optic devices to provide an optical communication channel. For example, a cable end connector may be connected, for example plugged, to a fiber optic device in the form of an optical transceiver which in turn may be connected to a networked device such as a host computer system, network switch, or server. When a cable connector is incompletely inserted into a fiber optic device, operation of an optical communication channel provided by the connection may be degraded and/or intermittent. Faulty connections caused by incomplete connector insertion can be very difficult to trace, particularly in communications and/or IT systems that comprise a large number of connections between cables and fiber optic devices. In some cases, connections may be disconnected to test the operational status of a fiber optic device and/or connector, resulting in inconvenience and/or inefficient usage of resources. Connectivity faults due to incomplete connector insertion may never be identified, for example, if a connection is disconnected to test the connector and/or fiber optic device, and subsequently the connector is completely inserted into the fiber optic device.

### BRIEF DESCRIPTION OF THE DRAWINGS

In order that the invention may be well understood, various embodiments thereof will now be described, by way of example only, with reference to the accompanying drawings, in which:

FIG. 1 is a schematic diagram in plan view showing selected elements of a fiber optic device and a fiber optic cable connector in a disengaged condition;

FIG. 2 shows the fiber optic device and the connector in a partially engaged to condition;

FIG. 3 shows the fiber optic device and the connector in a fully engaged condition;

FIG. 4 is a perspective view showing an exemplary fiber optic transceiver received in a housing of a host device, and a fiber optic cable connector;

FIG. 5 is a perspective view showing the transceiver of FIG. 4 and the housing;

FIG. 6 is a perspective view showing a vertical cross-section through the transceiver;

FIG. 7 is a schematic diagram in plan view illustrating the transceiver and a network device hosting the transceiver; and

FIG. 8 is a perspective view showing an underside of an exemplary fiber optic cable connector.

Drawings are schematic and not to scale.

### DETAILED DESCRIPTION

In accordance with some embodiments of the invention, a fiber optic device is connectable to a fiber optic cable connector to provide an optical communication channel. The fiber optic device comprises a first detection arrangement portion. The connector comprises a second detection arrangement portion. The first and second detection arrangement portions are operable to interact to provide a detection arrangement to detect a plurality of engagement conditions of the fiber optic device relative to the connector. The detection arrangement is operable to provide output signals, for example electronic or electrical signals, indicative of a present engagement condition of the connector relative to the fiber optic device. In at least some embodiments, for example, the first detection arrangement portion comprises a detector circuit, and the second detection arrangement portion comprises at least one detectable element configured and arranged to interact with the detector circuit to change an output of the detector circuit according to present relative dispositions of the fiber optic device and the connector. In alternative embodiments, for example, the first detection arrangement portion comprises at least one detectable element and the second detection arrangement portion comprises a detector circuit. That is, the detector circuit could be provided on the connector and the at least one detectable element could be provided on the fiber optic device.

The signals output from the detection arrangement can be used to communicate a present engagement condition externally of the fiber optic device, facilitating recognition by a user, such as a communications and/or IT system administrator, that a specific connection is incompletely made. In some embodiments, the present engagement condition is externally communicated, for example, using an LED (light emitting diode) and light pipe arrangement to display a light signal visible in use on the fiber optic device or connector, and/or by making present engagement condition data available to a networked device hosting the fiber optic device.

At least some embodiments facilitate the provision of a detection arrangement implementable in a relatively confined space and/or using low power and/or at relatively low cost. For example, an integrated circuit (IC) may be employed in the fiber optic device and/or in the connector to provide engagement status logic to process the detector circuit output, and/or to communicate a present condition externally of the fiber optic device. In some embodiments, the IC may comprise a specially adapted very low power RFID (radio frequency identification) tag. In some embodiments, the IC can have other, primary, functions in the fiber optic device and/or connector, for example to exchange identification and/or operating condition data between respective tags of a connector and a fiber optic device using IC to IC communication interfaces, and/or to report operating condition data through a networked device to a management database using an external data communication interface, and/or to control an on-board LED to display operating condition data externally using visible light indications. In at least some embodiments, the fiber optic device provides a power path, or line, to supply power to an IC in the connector, and the detection arrangement is connected to the power line to power the detector circuit.

Sometimes, particular combinations of interconnectable components exhibit non-linear insertion force patterns during connection. For example, as a connector is inserted into a fiber optic device there is sometimes an intermediate peak in the force necessary to insert the connector prior to the connector reaching a fully engaged position, that is, a position relative to the fiber optic device in which operation of the optical transmission channel will not be interrupted due to the connection being subjected to normal environmental operating conditions such as extraneous vibrations. Such a non-linear insertion force pattern can result in a person inserting the connector believing that full engagement has been achieved when he or she senses the intermediate peak in force, which in turn can lead to a resultant condition of partial engagement of a connector into a connectable device. In the partial engagement condition, there may at times be sufficient transmission in the optical channel to establish an optical communications link, but the transmission channel is susceptible to being interrupted from time to time and/or completely disrupted. Various embodiments in accordance with the present invention facilitate convenient and timely identification of connections that are in a partial engagement condition. Without the provision of embodiments according to the present invention, if a partial engagement condition of a connection results in intermittent transmission errors, a debug protocol might typically be performed relative to the connection to attempt to identify the cause of the problems, typically in many cases finding no problem with the connection. Subsequently, a protocol analyser might be used. During the procedure of connecting and disconnecting the protocol analyser to the fiber optic device, the connector would typically be disconnected and reinserted correctly into the fiber optic device, solving the partial engagement problem but with considerable cost and/or inconvenience, and without identification of the cause of the problem.

In some embodiments, the fiber optic device is an SFP (Small Formfactor Pluggable) type transceiver, for example an SFP+, SFP or SFF compliant transceiver. In alternative embodiments, the transceiver can be any other type of transceiver suitable for use in a communications and/or IT system. Where the fiber optic device is a transceiver, the transceiver in some embodiments receives power from a communications and/or IT device hosting the transceiver, and the transceiver provides power to the detection arrangement. In some alternative embodiments, the fiber optic device is, for example, a patch panel, adapter, or other cable end connector, and/or could be a passive device. Where the fiber optic device is not hosted by a powered communications and/or IT device, electrical power to power the detection arrangement can be provided in another way. For example, a low power detector circuit might receive power from an RFID tag provided in the fiber optic device and/or connector, for example using power scavenged using a parasitic power circuit of the RFID tag. In embodiments where the fiber optic device and connector include respective integrated circuits (ICs), and respective mating conductive traces on the fiber optic device and connector for the transmission of power from the fiber optic device to the connector IC, the power necessary to drive the detection arrangement can be drawn from the conductive traces. Also, engagement status logic for processing the output of the detection arrangement can be provided by the IC, for example as firmware in memory of the IC. Making multiple uses of functionality and/or devices provided in the fiber optic device and/or connector facilitates provision of a lower-cost and/or smaller dimension detection arrangement.

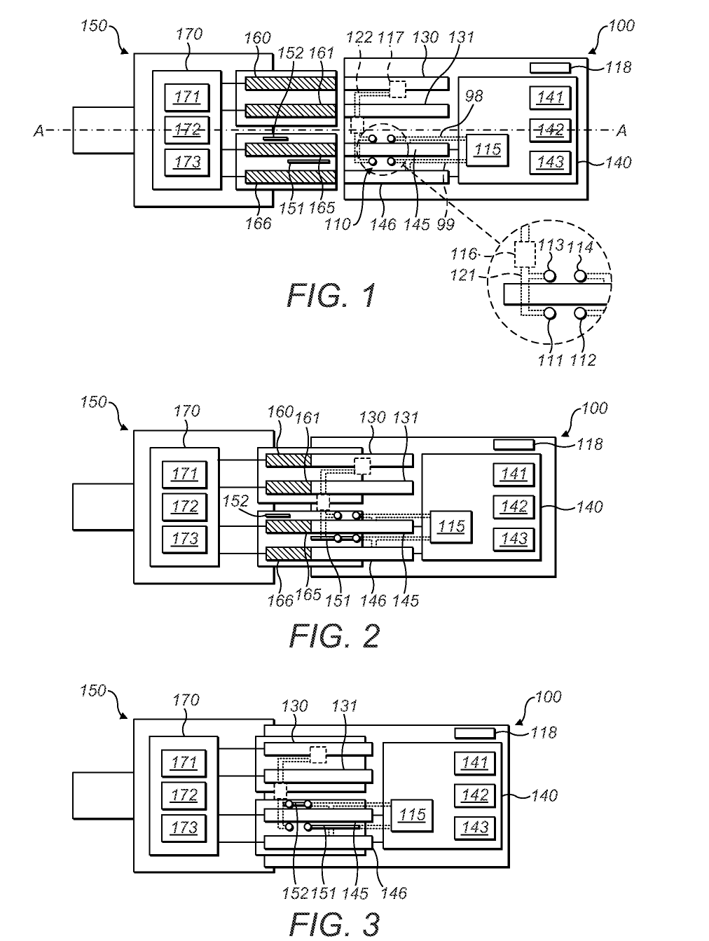

FIGS. 1 to 3 show, schematically and not to scale, selected elements of a fiber optic device 100 and a fiber optic cable connector 150. The fiber optic device 100 and the connector 150 are shown in disengaged (FIG. 1), partially engaged (FIG. 2) and fully engaged (FIG. 3) relative dispositions. The fiber optic device 100 comprises a first detection arrangement portion in the form of a detector circuit 110 comprising a first electrically conductive path, or line, 99 broken by a first pair of gapped contacts 111, 112 and a second electrically conductive path, or line, 98 broken by a second pair of gapped contacts 113, 114. Each of the first and second paths 99, 98 is respectively connected at one end to further circuitry including engagement status logic 115, for example in the form of a state machine, and at an opposite end to a pull up resistor 116. The pull up resistor 116 is connected through a connection 117 to a power supply, for example a power supply 118 of the fiber optic device 100. The connector 150 comprises a second detection arrangement portion in the form of first and second detectable elements 151, 152 respectively extending in a direction of an axis A-A of engagement and disengagement of the connector 150 relative to the fiber optic device 100. The first and second detection arrangement portions are configured and arranged to interact with one another and to vary an output of the detection arrangement in response to varying degrees of engagement of the fiber optic device 100 relative to the connector 150. The first and second detection arrangement portions provide a detection arrangement to detect a plurality of engagement conditions of the fiber optic device 100 relative to the connector 150, as described in further detail below.

In FIGS. 1 to 3, a conductive path 121 connects the contacts 111, 113 to the pull up resistor 116. A further conductive path 122 connects the pull up resistor 116 to the connection 117. Conveniently, at least some of the conductive paths 98, 99, 121, 122 and/or the pull up resistor 116 and/or the connection 117 can be disposed on an opposite side, relative to the contacts 111, 112, 113, 114, of a supporting structure on which the detector circuit 110 is arranged, as indicated by the use of broken lines in FIGS. 1 to 3.

The exemplary first and second detectable elements 151, 152 shown in FIGS. 1 to 3 comprise respective strips of conductive material, and the gapped contacts 111, 112, 113, 114 comprise respective conductive pads. The first detectable element 151 is aligned with the contacts 111, 112 so as to bridge the gap between the contacts 111 112 and close the circuit path 99 between the pull up resistor 116 and the engagement status logic 115 at a predetermined range or point of engagement of the connector 150 relative to the fiber optic device 100 in a direction of the axis A-A. The second detectable element 152 is aligned with the contacts 113, 114 so as to bridge the gap between the contacts 113, 114 and close the circuit path 98 between the pull up resistor 116 and the engagement status logic 115 at a further predetermined range or point of engagement of the connector 150 relative to the fiber optic device 100 in a direction of the axis A-A, the further range or point of engagement being different to the first-mentioned range or point of engagement. Conveniently, for example, the first pair of contacts 111, 112 is arranged in lateral alignment with (not offset from in a direction of the axis A-A) the second pair of contacts 113, 114, and the first and second detectable elements 151, 152 are offset from one another in a direction of the axis A-A.

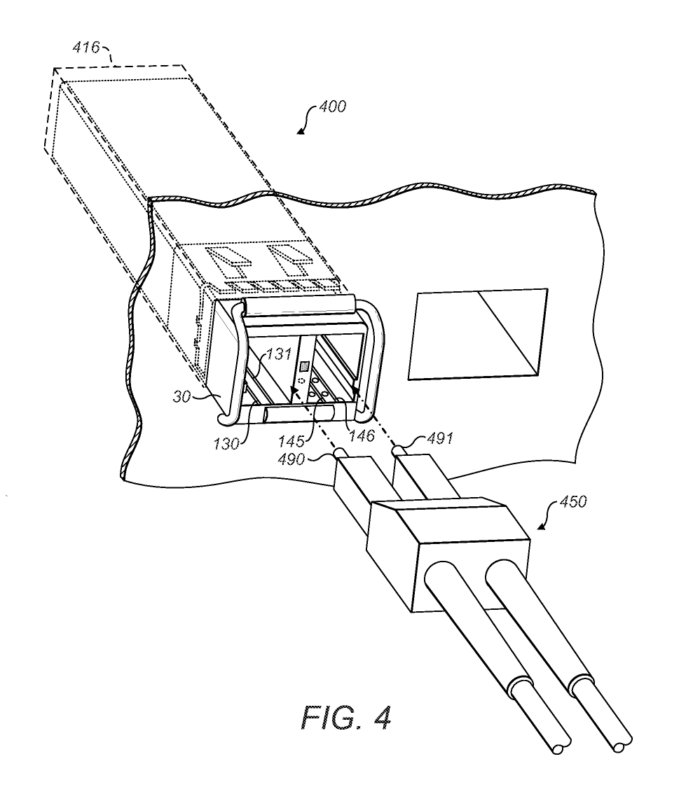

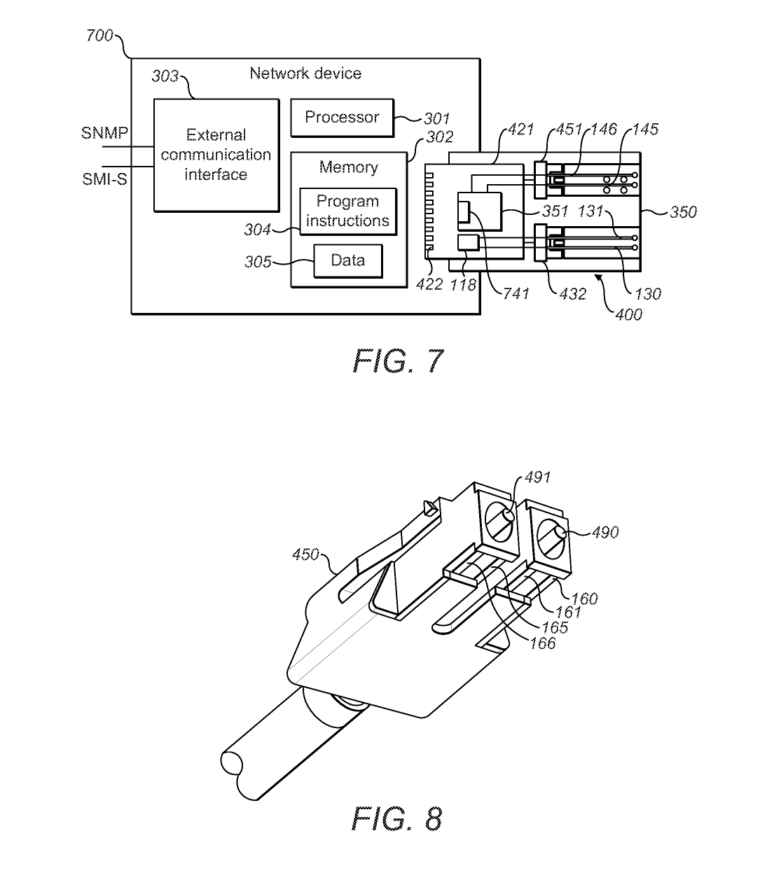

In FIG. 2, the connector 150 is shown in a partially engaged condition relative to the fiber optic device 100, in which condition one or more optical fibers (not shown in FIGS. 1 to 3, see for example optical fibers 490, 491 of the connector 450 in FIGS. 4 and 8, and TOSA 451 and ROSA 452 of the transceiver 400 in FIG. 7) of the connector 150 and the fiber optic device 100 would not be reliably interconnected, although some intermittent and/or degraded connectivity could be present. In the partially engaged condition, it can be seen from FIG. 2 that the first and second detectable elements 151, 152 have moved in a direction of the axis A-A, to the right in FIGS. 1 to 3. The first detectable element 151 now closes the gap between the first pair of contacts 111, 112. The second detectable element 152 does not close the gap between the second pair of contacts 113, 114. In FIG. 3, the connector 150 is shown in a fully engaged condition relative to the fiber optic device 100, in which the optical fibers of the connector 150 and the fiber optic device 100 would be reliably interconnected in good engagement. In the fully engaged condition, it can be seen from FIG. 3 that the first and second detectable elements 151, 152 have moved further along the axis A-A to the right. The second detectable element 152 now closes the gap between the second pair of contacts 113, 114. The first detectable element 151 does not close the gap between the first pair of contacts 111, 112. The detection arrangement 110, 151, 152 provides electronic output signals indicative of a present engagement condition. In the disengaged condition of FIG. 1, the engagement status logic 115 experiences a detector circuit output comprising an open circuit on path 99 and an open circuit on path 98. In the partially engaged condition of FIG. 2, the engagement status logic 115 experiences a detector circuit output comprising a closed-circuit on path 99 and an open circuit on path 98. In the fully engaged condition of FIG. 3, the engagement status logic 115 experiences a detector circuit output comprising an open circuit on path 99 and a closed-circuit on path 98.

It will be apparent to the ordinarily skilled person that variations of the specific arrangement shown in FIGS. 1 to 3 can be provided to detect plural engagement conditions of a fiber optic device relative to a connector. For example, the detector circuit 110 could be disposed on the connector, and the detectable elements disposed on the fiber optic device. In alternative embodiments, the first and second pairs of contacts 111, 112 and 113, 114 could be mutually offset in a direction of the axis A-A. In some embodiments, more or less than two detectable elements and more or less than two pairs of contacts may be provided. The detectable elements can take any convenient alternative shape. In some embodiments, the level of engagement could be continuously detected rather than detected in discrete levels or stages. The detector circuit 110 can also be implemented in different ways electrically, as desired. In one trivial exemplary variation, the circuit could be pulled low rather than pulled high.

In some embodiments, the fiber optic device 100 comprises at least one power supply line, or path. For example, power line 130 is connected to the power supply 118 and is arranged to extend along a direction of the axis A-A so as to conductively engage a corresponding power line 160 of the connector 150, for example to supply power to an integrated circuit (IC) 170 of the connector 150. The IC 170 of the connector comprises a processor element 171, a memory 172 and an IC-to-IC communication interface 173. The fiber optic device 100 also comprises a ground line 131 to conductively engage a ground line 161 of the connector 150. The detection arrangement 110, 151, 152 is connected by connection 117 to the power line 130 to power the detection circuit 110.

In some embodiments, the fiber optic device 100 comprises an integrated circuit (IC) 140 comprising a processor element 141, a memory 142 and an IC-to-IC communication interface 143. The fiber optic device 100 also comprises an IC-to-IC transmit communication line 145 and an IC-to-IC receive communication line 146 extending along a direction of the axis A-A so as to conductively engage corresponding IC-to-IC communication lines 165, 166 of the connector 150. The ICs 140, 170 enable the transmission of data between the fiber optic device 100 and the connector 150 through the communication lines 145, 146, 165, 166. The engagement status logic 115 may be provided by the integrated circuit 140, or in any other convenient manner, for example separately on the fiber optic device 100, or in some embodiments on the connector 150. The engagement status logic 115 can be provided using software and/or hardware, for example by firmware stored in the memory 142 of the IC 140 and/or by hardware logic circuitry of the IC 140. Making use of pre-existing elements of the fiber optic device 100 facilitates provision of the detection arrangement in a compact and/or economical manner. The engagement status logic 115 processes the present output signals from the detector circuit 110 and determines a present engagement condition. In some embodiments, data indicative of the present engagement condition is stored in memory of the fiber optic device 100, for example in the memory 142, and/or is used to communicate the present engagement condition externally of the fiber optic device 100 as described in further detail below.

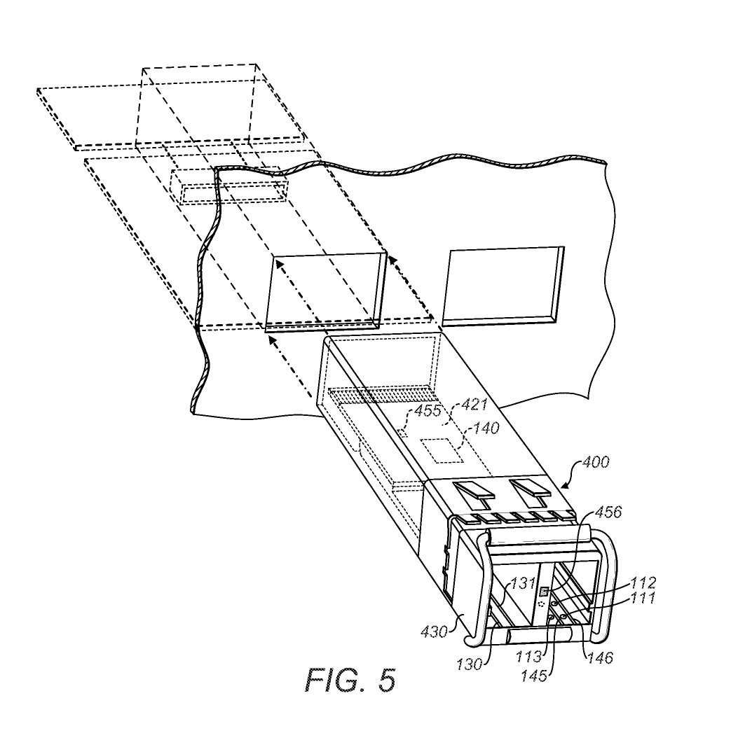

In some embodiments, the fiber optic device 100 comprises a fiber optic transceiver. An exemplary transceiver 400 is shown in FIGS. 4 to 8 together with an exemplary connector 450. The exemplary transceiver 400 is shown as an SFP-type optical transceiver having a mechanical interface according to the INF-8074i specification for (SFP) Small Formfactor Pluggable Transceiver published by the SFF Committee industry group. The term SFP-type as used herein relates to components that accord with any specification published by the SFF Committee that develops the SFP mechanical or electrical interface including, without limitation, specifications relating to SFP+ and QuadSFP. Embodiments of the invention are not limited to use with SFP-type optical transceivers. For example, embodiments of the invention can be applied to other types of optical transceiver, SFF (non-pluggable) connection components (also specified by SFF Committee specifications), removably pluggable SFP-type cable end connectors such as active optical cable connectors, and to any other suitable transceiver. The cable end connector 450 can be an LC connector, for example, as shown in FIGS. 4 and 8, or any other type of connector suitable for connection to a fiber optic device. The underside of the connector 450 can be seen in FIG. 8, including the power and ground lines 160, 161 and the transmit and receive lines 165, 166.

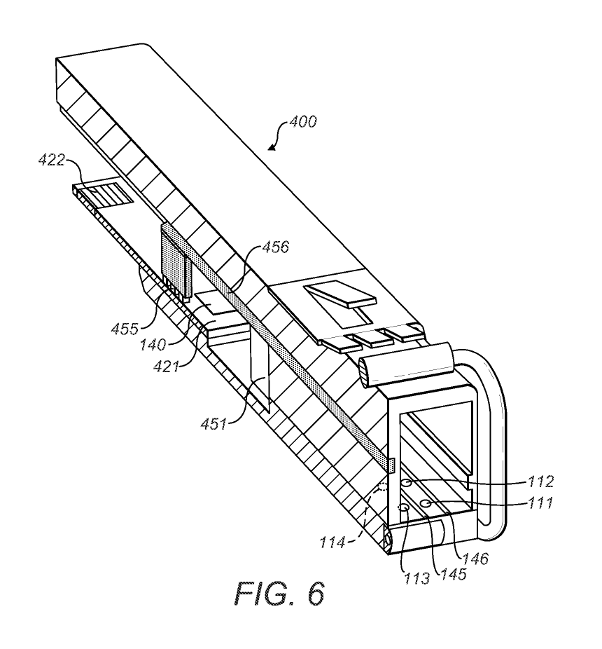

The transceiver 400 comprises a light emitting device in the form of at least one light emitting diode (LED) 455 (FIG. 6) connected to a printed circuit board (PCB) 421 at a location to the rear of a transmitter optical subassembly (TOSA) 451 and a receiver optical subassembly (ROSA) 452. The PCB 421 comprises an IC 140 as described with reference to FIGS. 1 to 3 above. The transceiver 400 comprises IC-to-IC communication paths 145, 146 and power and ground paths 130, 131, and a detector circuit 110, as described above with reference to FIGS. 1 to 3. The pairs of contacts 111, 112, 113, 114 of the detector circuit 110 are visible in FIGS. 4 to 7. For clarity, some essential components and circuitry for operation of the transceiver 400 is omitted from the drawings. For example, laser transmission control channel circuitry such as equalisation and laser driving circuitry connected to the TOSA 451, and laser receive channel circuitry such as transimpedance amplifier (TIA) and limiter circuitry connected to the ROSA 452 is omitted from the drawings. The transceiver 400 is removably received in a housing 416 of a network device 700 and is connected to the network device 700 through contacts 422 of the PCB 41. The LED can be controlled by the IC 140, including the engagement status logic, to act as a status light to indicate a present engagement condition of a connector 450 in the transceiver 400. The LED 455 can, for example, be a multicolour device, for providing a wider range of possible signals. The transceiver 400 further includes a light guide 456. The light guide 456 is configured to collect light from the LED 455 and guide the collected light to a front end portion 430 of the transceiver 400. The path of the light guide 456 passes from the region of the PCB 421, to emerge at the front of the transceiver 400. The IC 140 can control the LED 455 to provide visible indications at the front end of the transceiver 400. In use, with the transceiver 400 received in a host housing 416, the light guide 456 is thus configured to guide light from the LED 455 to locally provide externally visible indications indicative of a present engagement condition.

In some embodiments, the IC 140 further comprises a digital data communication interface 741 (FIG. 7), such as an I2C interface, and is operable to store present engagement condition data in the memory 142 and make the present engagement condition data, if desired together with other physical layer data, available through the digital data communication interface to a network device 700, for communicating the present engagement condition data to a network management database. In some embodiments, the exemplary network device 700 comprises a processor 301 a memory 302 and an external communication interface 303. The memory 302 stores computer program instructions 304, for example in the form of software and/or firmware, to provide at least some of the functionality of the network device 700. The network device 700 is operable to read present engagement condition data stored in memory on the transceiver 400, for example in the memory 142 of the IC 140, or in a separate memory such as EEPROM (not shown) provided on the transceiver 400. The received data can be stored by the network device 700, and communicated to a network manager over a network using the external communication interface 303 in accordance with any appropriate protocol, for example, in accordance with SMI-S (Storage are Management Initiative-Specification) or SNMP (Simple Network Management Protocol).

In alternative embodiments, the fiber optic device 100 comprises a patch panel, adapter, or another cable connector. In at least some embodiments, the integrated circuit 140 can be provided by a passive RFID tag, and power may be provided to the detector circuit 110 from a parasitic power supply of the RFID tag. In at least some embodiments, using a multi-function IC circuit which is very small, for example in the form of an IC tag or RFID tag, having major faces with a surface area of, say, less than or about 1 mm², facilitates the provision of fiber optic devices, enhanced according to various embodiments of the invention, in a compact manner, and/or with little increase in cost, and/or with low power requirements.

The above discussion is meant to be illustrative of the principles and various embodiments of the present invention. Numerous variations are modifications will become apparent to those skilled in the art once the above disclosure is fully appreciated. It is intended that the following claims be interpreted to embrace all such variations and modifications.

What is claimed is:

1. A fiber optic device connectable to a fiber optic cable connector to provide an optical communication channel, the fiber optic device comprising:
a first detection arrangement portion operable to interact with a second detection arrangement portion of the connector to provide a detection arrangement to detect a plurality of engagement conditions of the fiber optic device relative to the connector, including partial engagement and good engagement, and to provide output signals indicative of a present engagement condition.

2. The fiber optic device of claim 1, one of the first and second detection arrangement portions comprising a detector circuit adapted to detect at least a disengagement condition, a partial engagement condition and a good engagement condition, and the other of the first and second detection arrangement portions comprising at least one detectable element configured and arranged to change the detector circuit output according to a present relative disposition of the fiber optic device and the connector.

3. The fiber optic device of claim 2, the detector circuit comprising a first pair of gapped contacts configured to be electrically interconnected by a first conductive detectable element in a first engagement position of the fiber optic device and the connector in response to relative movement of the fiber optic device and the connector in a direction of an axis of inter-engagement, and a second pair of gapped contacts configured to be electrically interconnected by a second conductive detectable element in a second engagement position of the fiber optic device and the connector in response to further relative movement of the fiber optic device and the connector in the direction of the axis of inter-engagement.

4. The fiber optic device of claim 1, the detector circuit and detectable elements configured and arranged such that one of the first and second pairs of gapped contacts is closed only if the other of the pairs is not closed.

5. The fiber optic device of claim 1, further comprising at least one power line and at least one communication line arranged and configured to interconnect with corresponding respective power and communication lines of the connector, the detection arrangement being connected to a said power line power the detection circuit.

6. The fiber optic device of claim 5, comprising a fiber optic transceiver comprising an integrated circuit (IC) having a processor element, memory and an IC-to-IC communication interface, the communication lines of the transceiver extending from the IC at the and arranged and configured to interconnect with corresponding communication lines extending from an IC of the connector to communicate optical subsystem physical layer operating condition data between the ICs.

7. The fiber optic device of claim 1, operable to use the electronic output signal and communicate the present engagement condition externally of the fiber optic device.

8. The fiber optic device of claim 1, comprising a fiber optic transceiver having an IC, an LED and a light pipe from the LED to an externally visible portion of the transceiver, the IC including engagement status logic to cause the IC to control the LED in accordance with the output signals to externally display light signals indicative of a present engagement condition.

9. The fiber optic device of claim 1, comprising a fiber optic transceiver having an IC including engagement status logic and a digital data communication interface, and operable to make the present engagement condition data available through the digital data communication interface in real time to a network device hosting the transceiver.

10. The fiber optic device of claim 1, the detection arrangement being connected to engagement status logic comprising a state machine.

11. The fiber optic device of claim 1, comprising an SFP+, SFP or SFF compliant transceiver.

12. A fiber optic cable end connector connectable to the fiber optic device of claim 1 to establish an optical communication channel, the connector comprising:
a second detection arrangement portion operable to interact with a first detection arrangement portion of the fiber optic device to provide a detection arrangement to detect a plurality of engagement conditions of the fiber optic device relative to the connector, including partial engagement and good engagement, and provide output signals indicative of a present engagement condition.

13. The fiber optic cable end connector of claim 12, one of the first and second detection arrangement portions comprising a detector circuit adapted to detect at least a disengagement condition, a partial engagement condition and a good engagement condition, and the other of the first and second detection arrangement portions comprising at least one detectable element configured and arranged to change the detector circuit output according to a present relative disposition of the fiber optic device and the connector.

14. The fiber optic cable end connector of claim 13, the detector circuit comprising a first pair of gapped contacts configured to be electrically interconnected by a first conductive detectable element in a first engagement position of the fiber optic device and the connector in response to relative movement of the fiber optic device and the connector in a direction of an axis of inter-engagement, and a second pair of gapped contacts configured to be electrically interconnected by a second conductive detectable element in a second relative engagement position of the fiber optic device and the connector in response to further relative movement of the fiber optic device and the connector in the direction of the axis of inter-engagement.

15. The fiber optic cable end connector of claim 13, the second detection arrangement portion comprising the at least one detectable element.

16. The fiber optic cable end connector of claim 12, comprising a power line connectable to a power line of the transceiver of claim 6 to power an integrated circuit (IC) of the connector, the IC being operable to communicate optical subsystem physical layer operating condition data with the IC of the transceiver, the detection arrangement being connected to a power line of the connector and/or the transceiver to power the detection circuit.

17. A transceiver having engagement status logic and a detector circuit configured to engage with a corresponding at least one respective conductive element of a cable connector such that, during insertion of the cable connector into the transceiver, different electrical signals are provided to the engagement status logic corresponding to different levels of insertion of the cable connector into the transceiver.

18. The transceiver of claim 17, the detector circuit comprising a plurality of bridgeable circuit gaps, the gaps arranged to be electrically closed to permit conduction thereacross by the at least one conductive element of the connector according to the present level of insertion of the cable connector into the transceiver.

19. The transceiver of claim 18, the connector comprising a plurality of conductive elements, the conductive elements and/or the gaps being offset from other conductive elements and/or gaps in a direction of an axis of inter-engagement of the transceiver and the connector.

20. The transceiver of claim 17, the transceiver further comprising a power line to power an integrated circuit (IC) of the connector, and communication lines extending from a very low power IC of the transceiver to interconnect with corresponding communication lines extending from the IC of the connector to communicate physical layer operating condition data between the ICs, the detector circuit being connected to receive power from the power line for powering the detector circuit.
